(19) United States
(12) Patent Application Publication
(10) Pub. No.: US 2018/0246968 A1
(43) Pub. Date: Aug. 30, 2018

(54) EVENT PROCESSING SYSTEM

(71) Applicant: Mediasift Limited, Reading (GB)

(72) Inventors: Timothy BARKER, Berkshire (GB); Timothy David BUDDEN, Henley on Thames (GB); Lorenzo ALBERTON, Reading (GB)

(21) Appl. No.: 15/445,904

(22) Filed: Feb. 28, 2017

(51) Int. Cl. G06F 17/30; G06Q 10/06; H04L 29/06

(52) U.S. Cl. CPC G06F 17/30864; H04L 63/10; G06Q 10/0631

(57) ABSTRACT

A system for processing user events of a platform having a plurality of users comprises: a customer data interface configured to receive from a customer management system customer data and release authorization data for the customer data; an input configured to receive user events of the platform, each comprising an identifier of at least one of the users; an attribute manager configured to determine, for the users of the platform, user attributes of a first type from user data of the platform and user attributes of a second type from the customer data; a query handler configured to respond to submitted queries by selectively releasing aggregate information related to user events; and a processing component configured to process the user events and the user attributes to extract the aggregate event-related information for release. The query handler is configured to restrict the release of aggregate event-related information pertaining to the second type of user attribute according to the release authorization data received for the customer data.

### TECHNICAL FIELD

The present invention relates to a system for processing events.

### BACKGROUND

There are various contexts in which it is useful to extract aggregated and anonymized information relating to users of a platform.

Understanding what content audiences are publishing and consuming on social media platforms has been a goal for many for a long time. The value of social data is estimated at $1.3 trillion but most of it is untapped. Extracting the relevant information is challenging because of the vast quantity and variety of social media content that exists, and the sheer number of users on popular social media platforms, such as Facebook, Twitter, LinkedIn etc. It is also made even more challenging because preserving the privacy of the social media users is of the utmost importance.

A data platform that is available today under the name DataSift connects to real-time feeds of social data from various social media platforms (data sources), uncovers insights with sophisticated data augmentation, filtering and classification engine, and provides the data for analysis with an appropriate privacy protocol required by the data sources.

It allows insights to be drawn from posts, shares, re-shares, likes, comments, views, clicks and other social interactions across those social media platforms. A privacy-first approach is adopted to the social media data, whereby (among other things) results are exclusively provided in an aggregate and anonymized form that makes it impossible to identify any of the social media users individually.

### SUMMARY

The present invention allows a proprietor of customer data (brand) to join their own CRM records (customer data) to activities recorded by a platform provider. The key points here are:
1. there are two parties which have a common subset of users/customers, each with its own set of attributes associated to their users/customers;
2. at least one of the two parties could benefit from an aggregated analysis over both sets of properties and over behaviour/activity of their own users/customers on the other “network” (platform);
3. the analysis itself is performed in an aggregated and anonymised fashion, to protect privacy of individuals.

One of the parties can be a social media platform, which acts as a data provider to provide information about social interactions on the social media platform, so that the other party can extract relevant aggregate information about the social interactions in an aggregate and anonymized form. Various examples of this are described below.

However, the present invention is not limited to this. For example, the data provider could be a car-hire/ride-share company (e.g. Uber or a cab company), providing data about car trips. This allows, for example, a supermarket brand to use traffic information from the data provider for shop placement decisions. For example, with the present invention, the supermarket brand is able to pass some of its own customers' properties (potentially obfuscated) to the car-hire/ride-share platform and gather extended information, in aggregated and anonymized form, about the activity of their customers on the car-hire/ride-share platform.

Accordingly, some, but not all, aspects of the present invention relate to a content processing system for extracting aggregate information relating to the publication and consumption of content on a content publishing platform.

In any event, another key aspect of the present invention is the ability it provides for proprietors of customer data to restrict the circumstances under which aggregate information derived from their customer data can be released to users of the event processing system. In this manner, the proprietor of the customer data retains complete control over the customer data they are providing to the event processing system.

A first aspect of the present invention is directed to a content processing system for processing content items of a content publication platform having a plurality of users, the content processing system comprising: a customer data interface configured to receive from a customer management system customer data and release authorization data for the customer data; a content input configured to receive content items of the content publication platform, each relating to a piece of published content and comprising an identifier of at least one of the users who has published or consumed it; an attribute manager configured to determine, for the users of the content publishing platform, user attributes of a first type from user data of the content publication platform and user attributes of a second type from the customer data; a query handler configured to respond to submitted queries by selectively releasing aggregate content-related information; and a content processing component configured to process the content items and the user attributes to extract the aggregate content-related information for release; wherein the query handler is configured to restrict the release of aggregate content-related information pertaining to the second type of user attribute according to the release authorization data received for the customer data.

In embodiments, the user attributes of the second type may be uninterpretable tokens.

In embodiments, a data processing system may be provided, which comprises such a content processing system and a customer data modifier configured to modify customer data from a customer database of the customer management system to replace interpretable user attributes therein with the uninterpretable tokens, and provide the modified customer data to the content processing system via the customer data interface for processing, wherein the interpretable user attributes are not rendered accessible to the content processing system.

The customer data modifier may be configured to receive a query comprising at least one of the interpretable user attributes, and modify that query for submission to the query handler by replacing the interpretable attribute with a corresponding one of the uninterpretable tokens.

For each of the queries, the aggregate content-related information to be released may be extracted by the content processing component in response to the submission of that query to content processing system.

The content processing component may be configured to filter the content items according to the user attributes; wherein the query handler may be configured to refuse a query requesting information for content items filtered according to the second type of user attribute unless authorized by the release authorization data.

The content processing component may be configured to filter content items according to metadata of the content items; wherein the query handler may be configured to release aggregate content-related information extracted from the filtered content items and pertaining to the second type of user attribute only when authorized by the release authorization data.

Aggregate content-related information pertaining only to the first type of user attribute may be released to any authorized user of the content processing system.

The content processing system may comprise a content manager configured to anonymize the identifiers of the users in the content items before they are processed by the content processing component.

The attribute manager may be configured to associate the user attributes with the anonymized user identifiers for processing by the content processing component.

The attribute manager may be configured to determine the attributes for the users by matching user identity data in the customer data to user identity data in the user data of the content publication platform.

The identity data can for example comprises email addresses, device identifiers, public user identifiers and/or telephone numbers, and/or any other type of user identity data.

The release authorization data may indicate at least one entity for which the release of the aggregate content-related information pertaining to the second type user attribute is authorized.

For example the authorized entity may be:
an organization,
a device,
a user,
an account within the content processing system, or
a network address.

For example, the release authorization data may comprise a credential or an authentication token for the account within the content processing system, thereby indicating the account.

The content processing component may comprise an augmentation component configured to augment the content items with the user attributes, each of the augmented content items comprising a copy of the user attributes associated with its user identifier.

The content processing component may comprise an enrichment component configured to generate metadata from the pieces of content and enrich the content items with the metadata, each of the enriched content items comprising the metadata derived from its piece of content.

A second aspect of the present invention is directed to a method of processing content items of a content publication platform having a plurality of users, the method comprising, at a content processing system: receiving, via a customer data interface from a customer management system, customer data and release authorization data for the customer data; receiving content items of the content publication platform, each relating to a piece of published content and comprising an identifier of at least one of the users who has published or consumed it; determining, for the users of the content publishing platform, user attributes of a first type from user data of the content publication platform and user attributes of a second type from the customer data; responding to submitted queries by selectively releasing aggregate content-related information, the aggregate content-related information being extracted for release by processing the content items and the user attributes, wherein the release of aggregate content-related information pertaining to the second type of user attribute is restricted according to the release authorization data received for the customer data.

A third aspect of the present invention is directed to a computer program product comprising executable instructions stored on a computer readable storage modicum and configured when executed at a content processing system to implement any method or system functionality disclosed herein.

A fourth aspect of the present invention is directed to a system for processing user events of a platform having a plurality of users, the system comprising: a customer data interface configured to receive from a customer management system customer data and release authorization data for the customer data; an input configured to receive user events of the platform, each comprising an identifier of at least one of the users; an attribute manager configured to determine, for the users of the platform, user attributes of a first type from user data of the platform and user attributes of a second type from the customer data; a query handler configured to respond to submitted queries by selectively releasing aggregate information related to user events; and a processing component configured to process the user events and the user attributes to extract the aggregate event-related information for release; wherein the query handler is configured to restrict the release of aggregate event-related information pertaining to the second type of user attribute according to the release authorization data received for the customer data.

In this context, each event can be any event relating to the user with which it is associated. Each of the user events may relate to an action performed by or otherwise relating to one of the users of the platform and comprise an identifier of that user. That is, each of the user events may be a record of a user-related action on the platform.

The platform can be any platform with a user base that facilitates user interactions. The platform provider could for example be a telecoms operator like Vodafone or Verizon, a car-hire/ride-share platform like Uber, an online market place like Amazon, a platform for managing medical records etc. The “interactions” can for example be calls, car rides, financial transactions, changes to medical records etc. conducted, performed or arranged via the platform, where the interaction items constitute records of those interactions. The invention allows a proprietor of customer data (brand) to join their own CRM records (customer data) to activities recorded by the platform provider.

In this respect, it is noted that all description pertaining to interaction events of a social media platform (content items) herein applies equally to other types of events of platforms other than social media. Such events can comprise or be associated with user attributes and/or metadata for the actions to which they relate, allowing those events to be processed (e.g. filtered and/or aggregated) using any of the techniques described herein.

### BRIEF DESCRIPTION OF FIGURES

For a better understanding of the present invention, and to show how embodiments of the same may be carried into effect, reference is made by way of example to the following figures in which:

FIG. 1A shows a schematic block diagram of an index builder of a content processing system;

FIG. 1B shows a schematic block diagram of a real-time filtering and aggregation component of a content processing system;

FIG. 2 shows a schematic block diagram of a computer system in which a content processing system can be implemented;

FIG. 3A shows a schematic overview of a content processing system in accordance with the present invention;

FIG. 3B shows a more detailed schematic block diagram of the content processing system of FIG. 3A;

FIG. 3C shows further details of a content processing component of the content processing system of FIG. 3A.

### DETAILED DESCRIPTION OF EMBODIMENTS

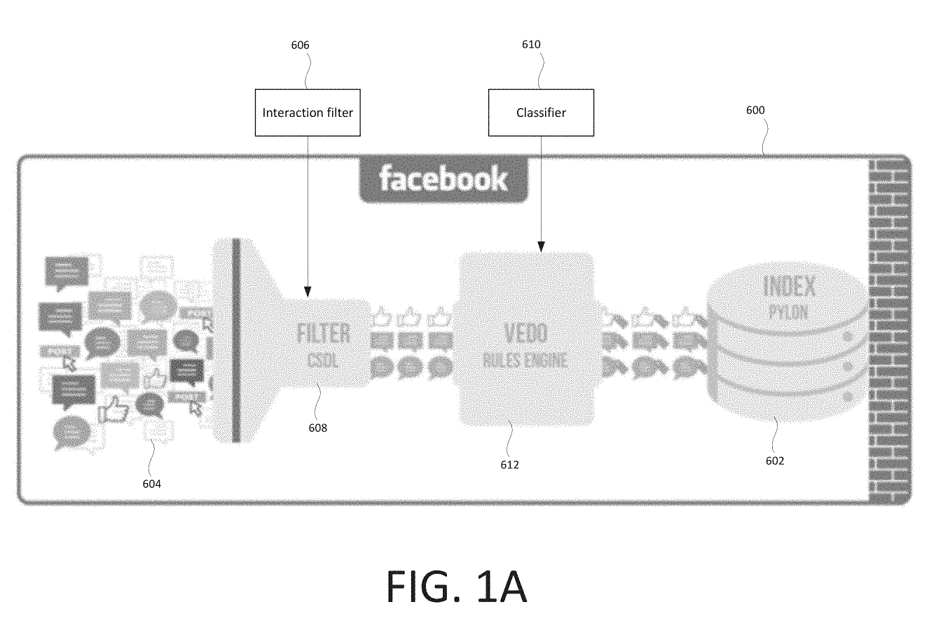

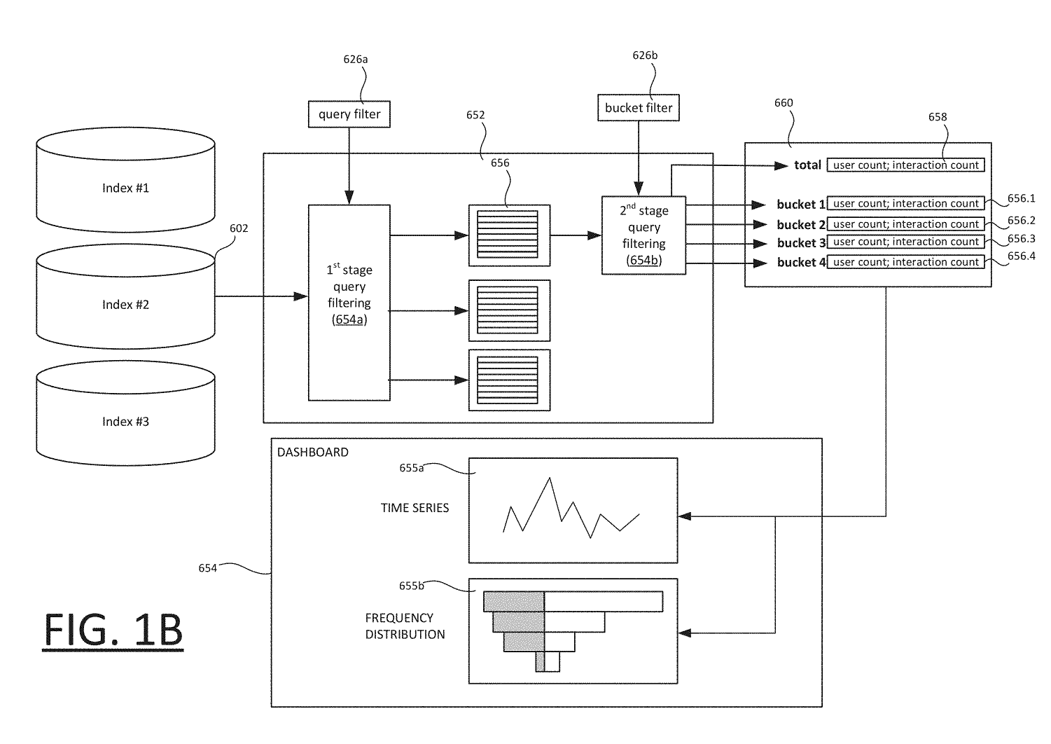

FIG. 1A shows a high level overview of part of a content processing system for processing content items 604 of a social media platform.

Each of the content items 604—also called “interaction events” or simply “events” herein—is a record of an “interaction” on the social media platform (social interaction), which can be a social media user publishing a new piece of content or consuming an existing piece of content. Examples of different publishing or consuming actions are given later. The events are provided by the social media platform, which is referred to as a “data provider” in this context. They are provided as a real-time data stream or multiple real-time data streams (e.g. different streams for different types of events), also referred to as “firehoses” herein. That is, the events 604 are received in real-time at an index builder 600 of the content processing system as the corresponding social interactions take place.

Indexes, such as index 602, can be created within the index builder 600. An index is a database in which selectively-made copies of the events 602 are stored for processing. An index can for example be a bespoke database created by a querying user for his own use, i.e. a user of the content processing system who wishes to submit queries to it (such as a customer), or it can be a shared index created by an operator of the content processing system for use by multiple customers. The index 602 holds copies of selected events 604, which are selected by a filtering component 608 of the index builder 600 according to specified filtering rules. These filtering rules are defined in what is referred to herein as an “interaction filter” 606 for the index 602. Viewed in slightly different terms, an index can be seen as a partial copy of a global database (the global database being the set of all events received from the data provider) that is populated by creating copies of the events 604 that match the interaction filter 606.

The index 602 can be created in a “recording” process, which is initialized by providing an interaction filter 606 and which runs from a timing of the initialization to capture events from that point onwards as they occur in real-time. It may also be possible for an index to contain historical events. The interaction filter 608 is applied by the filtering component 608 in order to capture events matching the interaction filter 606, from the firehoses, as those events become available. The process is a real-time process in the sense that it takes as an input the “live” firehoses from the data provider and captures the matching events in real-time as new social interactions occur on the social media platform. The recording process continues to run until the customer 606 (in the case of a bespoke index) or service provider (in the case of a shared index) chooses to suspend it, or it may be suspended automatically in some cases, for example when system limits imposed on the customer are breached.

Each of the events 604 comprises a user identifier of the social media user who has performed the corresponding interaction. As explained in further detail later, by the time the events 604 arrive at the filtering component 608, preferably every one of the events comprises a copy of the content to which it relates; certain “raw” events, i.e. as provided by the data provider, may not include the actual content when first provided, in which case this can be obtained and added in an “augmentation” stage of the content processing system, in which “context building” is performed.

User attributes of the social media users are made available by the data provider from user data of the social media platform, for example from the social media users' social media accounts (in a privacy-sensitive manner—see below). Such user attributes may be are self-declared, i.e. the social media users have declared those attributes themselves or derived from self-declared attributes, for example inferring an age range from a graduation year attribute (in contrast to user attributes that need to be inferred from, say, the content itself). The attributes may be provided separately from the raw events representing the publication and consumption of content from the data provider. For example, an attribute firehose may be provided that conveys the creation or modification of social media profiles in real-time. In that case, as part of the context building, the events 604 relating to the publication and consumption of content can be augmented with user attributes from the attribute firehose, such that each of the augmented events 604 comprises a copy of a set of user attributes for the social media user who has performed the interaction. Additional attributes may also be inferred during “enrichment” (see below).

The idea behind context building is to add context to events that lack it in some respect. For example, a user identifier (ID) in an incoming event may simply be an anonymized token (to preserve user privacy) that has no meaning in isolation; by adding user attributes association. In database terminology, context building can be viewed a form of de-normalization (vertical joining). Another example when a data provider provides a separate firehoses of “likes” or other engagements with previous events.

The customer or service provider is not limited to simply setting the parameters of his interaction filter 606; he is also free to set rules by which the filtered events are classified, by a classification component 612 of the index builder 600. That is, the customer/service provider has the option to create a classifier 610 defining classification rules for generating and attaching metadata to the events before they are stored in the index 602. These classification rules can, for example, be default or library rules provided via an API of the content processing system, or they can be rules which the customer or service codes himself for a particular application.

Individual pieces of metadata attached to the events 604 are referred to herein as “tags”. Tags can include for example topic indicators, sentiment indicators (e.g. indicating positive, negative or neutral sentiment towards a certain topic), numerical scores etc., which the customer or service provider is free to define as desired. They could for example be rules based on simple keyword classification (e.g. classifying certain keywords as relating to certain topics or expressing positive sentiment when they appear in a piece of content; or attributing positive scores to certain keywords and negative scores to other keywords and setting a rule to combine the individual scores across a piece of content to give an overall score) or using more advanced machine learning processing, for example natural language recognition to recognize sentiments, intents etc. expressed in natural language or image recognition to recognize certain brands, items etc. in image data of the content. The process of adding metadata tags to events, derived from the content to which they relate, is referred to as “enrichment” below. As part of the enrichment, additional user attributes may also be inferred from the content (e.g. by profiling users over time to infer their interests) or from a third party.

In addition to bespoke tags added through enrichment, the events may already have some tags when they are received in the firehoses, for example time stamps indicating timings of the corresponding interactions, geolocation data etc.

With the (additional) tags attached to them in this manner according to the customer's bespoke definitions, the filtered and enriched events are stored in the index 602, populating it over time as more and more events matching the interaction filter 608 are received.

Multiple indexes can be created in this manner, tailored to different applications in whatever manner the service provider/customers desire.

It is important to note that, in the case of private social media data in particular, even when the customer has created the index 602 using his own rules, and it is held in the content processing system on his behalf, he is never permitted direct access to it. Rather, he is only permitted to run controlled queries on the index 602, which return aggregate information, derived from its contents, relating to the publication and/or consumption of content on the content publication platform. The aggregate information released by the content processing system is anonymized i.e. formulated and released in a way that makes it impossible to identify individual social media users. This is achieved in part in the way the information is compiled based on interaction and unique user counts (see below) and in part by redacting information relating to only a small number of users (e.g. less than one hundred).

Queries are discussed in greater detail below but for now suffice it to say that two fundamental building blocks for the anonymized aggregate information are:
1) interaction counts, and
2) associated unique user counts.

These counts can be generated either for the index 602 as a whole or (in the majority of cases) for a defined subset of the events in the index 602, isolated by performing further filtering of the events held in the index 602 according to “query filters” as they are referred to herein. Taken together, these convey the number of interactions per unique user for the (sub)set of events in question, which is a powerful measure of overall user behaviour for the (sub)set of events in question.

The interaction count is simply the number of events in the index 306 or subset, and the unique user count is the number of unique users across those events. That is, for a query on the whole index 602, the number of events that satisfy (match) the index's interaction filter 606 and the number of unique social media users who collectively performed the corresponding interactions; for a query on a subset of the index 602 defined by a query filter(s), the interaction count is the number of events that also match that query filter(s) (e.g. 606a, 606b, FIG. 1B—see below) and the number of unique social media users who collectively performed the corresponding subset of interactions. Successive query filters can be applied, for example, to isolate a particular user demographic or a particular set of topics and then breakdown those results into “buckets”. Note, this does not mean successive queries have to be submitted necessarily; a single query can request a breakdown or breakdowns of results, and the layers of filtering needed to provide this breakdown can all be performed in response to that query. For example, results for a demographic defined in terms of gender and country could be broken down as a time series (each bucket being a time interval), or in a frequency distribution according to gender, most popular topics etc. These results can be rendered graphically on user interface, such as a dashboard, in an intuitive manner. This is described in greater detail later.

For example, to aggregate by gender (one of “Male”, “Female”, “Unknown”) and age range (one of “18-25”, “25-35”, “35-45”, “45-55”, “55+”), in the response to an aggregation query (unique user and interaction) counts may be generated for each of the following buckets:

Bucket

Male, 18-25
Male, 25-35
Male, 35-45
Male, 45-55
Male, 55+
Female, 18-25
Female, 25-35
Female, 35-45
. . .
Unknown, 55+

Despite their simplicity, these fundamental building blocks are extremely powerful, particularly when coupled with the user attributes and bespoke metadata tags in the enriched events in the index 602. For example, by generating interaction and user counts for different subsets of events in the index 602, which are isolated by filtering according to different combinations of user attributes and tags, it is possible for an external customer to extract extremely rich information about, say, the specific likes and dislikes of highly targeted user demographics (based on the social interactions exhibited across those demographics) or the most popular topics across the index or subset thereof, without ever having to permit the external customer direct access to the index 602 itself.

For example, a useful concept when it comes to identifying trends within particular user demographics is the concept of “over-indexing”. This is the notion that a particular demographic is exhibiting more interactions of a certain type than average. This is very useful when it comes to isolating behaviour that is actually specific to a particular demographic. For example, it might be that within a demographic, a certain topic is seeing a markedly larger number of interactions per unique user than other topic (suggesting that users are publishing or consuming content relating to that topic more frequently). However, it might simply be that this is a very popular topic, and that other demographics are also seeing similar numbers of interactions per unique user. As such, this conveys nothing specific about the target demographic itself. However, where, say, a topic is over-indexing for a target user demographic, i.e. seeing a greater number of interactions per unique user across the target demographic than the number of interactions per unique user across a wider demographic, then that coveys information that is specific to the target demographic in question.

By way of example, FIG. 1B shows a real-time filtering and aggregation component 652 of the content processing system implementing steps to respond to a query with two stages of filtering to give a breakdown in response to that query.

In the first stage of filtering 654a, a first query filter 626a is applied to the index 602 (shown as one of multiple indexes) to isolate a subset of events 656 that match the first query filter 626a. The first query filter 626a can for example be defined explicitly in the query by the customer, in order to isolate a particular demographic(s) of users of a particular topic(s) (or a combination of both) that is of interest to him.

In the second state of filtering 654b, second query filters 262b (bucket filters) are applied to the subset of events 656. Each of the bucket filters is applied to isolate the events in the subset 656 that satisfy that bucket filter, i.e. the events in a corresponding bucket, so that total interaction and user counts can be computed for that bucket. The total user and interaction counts for each bucket (labelled 656. 1-4 for buckets 1-4 in this example) are included, along with total user and interaction counts for the subset of events 656 as a whole, in a set of results 660 returned in response to the query. The results 660 are shown rendered in a graphical form on a user interface, which is a dashboard 654. That is, the result 660 is represented as graphical information displayed on a display to the customer. The underlying set of results 660 can also be provided to the customer, for example in a JSON format, so that he can apply his own processing to them easily.

Multiple subsets can be isolated in this way at the first stage filtering 626a, and each can be broken down into buckets as desired at the second stage 626b.

The buckets can for example be time based, i.e. with each bucket containing events in the subset 656 within a different time interval. These are shown rendered on the dashboard 654 as a graphical time series 655a, with time along the x-axis and the counts or a measure derived from the counts (such as number of interactions per unique user) on the y-axis, which is a convenient and intuitive way of representing the breakdown according to time. As another example, the buckets could be topic based (e.g. to provide a breakdown of the most popular topics in the subset 656) or user based (e.g. to provide a breakdown according to age, gender, location, job function etc.), or a combination of both. In this case, it may be convenient to represent the results as a frequency distribution or histogram 655b, to allow easy comparison between the counts or a measure derived from the counts (e.g. interactions per user) for different buckets. As will be appreciated, these are just examples, and it possible to represent the results for the different buckets in different ways that may be more convenient in some contexts. The information for each bucket can be displayed alongside the equivalent information for the subset 656 as a whole for comparison, for example by displaying on the dashboard 654 the total user and interaction counts or the total number of interactions per unique user across the subset 656 as a whole etc. The dashboard 654 can for example provided as part of a Web interface accessible to the customer via the Internet.

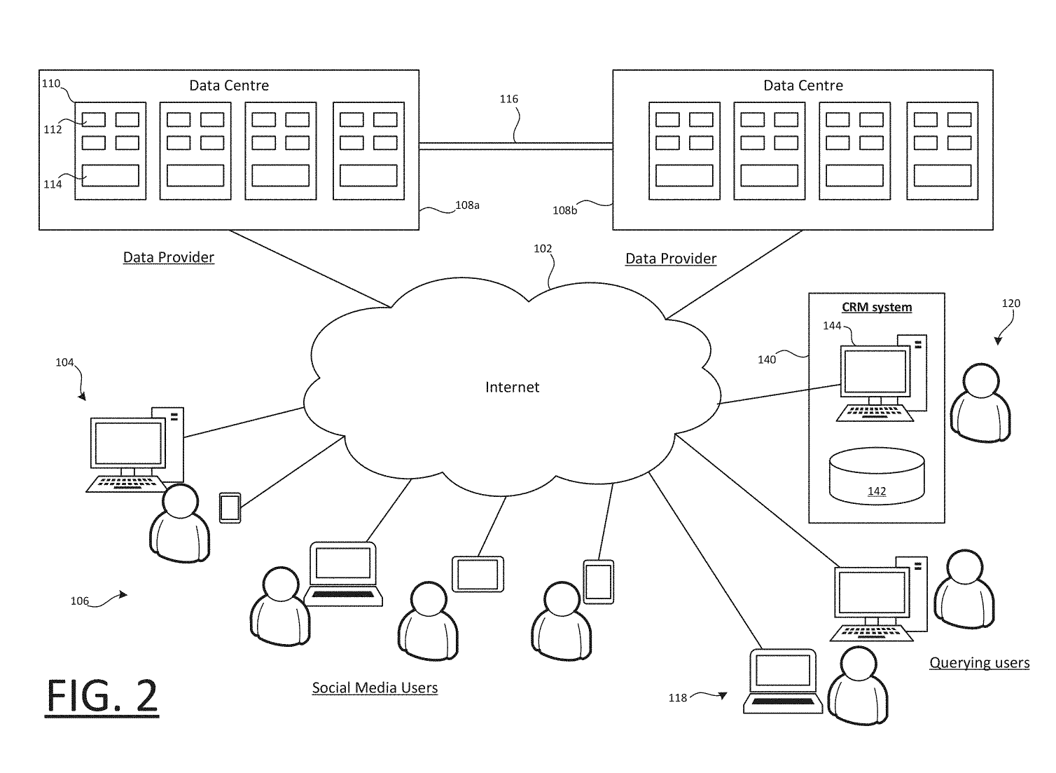

FIG. 2 shows a schematic block diagram of a computer system in which various devices are connected to a computer network 102 such as the Internet. These include user devices 104 connected to the network 102 and which are operated by users 106 of a social media platform.

The term “social media platform” refers herein to a content publication platform, such as a social network, that allows the social media users 106 to interact socially via the social media platform, by publishing content for consumption by other social media users 106, and consume content that other social media users 106 have published. A social media platform can have a very large number of users 106 who are socially interacting in this manner—tens of thousands or more with the largest social media platform today currently having user bases approaching 2 billion users. The published content can have a variety of formats, with text, image and video data being some of the most common forms. A piece of published content can be “public” in the sense that it is accessible to any user 106 of the social media platform (in some cases an account within the social media platform may be needed, and in others it may be accessible to any Web user), or it can be “private” where it is rendered accessible to only a limited subset of the social media users 106, such as the publishing user's friends. That is, private content is rendered accessible to only a limited audience selected by the user publishing it. Friendships and other relationships between the users 106 of the social media platform can be embodied in a social graph of the social media platform, which is a computer-implemented data structure representing those relationships in a computer readable format. Typically, a social media platform can be accessed from a variety of different user devices 104, such as smart phones, tablets and other smart devices, or other general purpose computing devices such as laptop or desktop computers. This can be via a web browser or alternatively a dedicated application (app) for the social media platform in question. Examples of social media platforms included LinkedIn, Facebook, Twitter, Tumblr etc.

Social media users 106 can publish content on the social media platform by generating new content on the platform such as status updates, posts etc., or by publishing links to external content, such as articles etc. They can consume pieces of content published by other social media users 106 for example by liking, re-sharing, commenting on, clicking on or otherwise engaging with that content, or simply having that content displayed to them without actively engaging with it, for example in a news feed etc. (that is, displaying a piece of content to a social media user is considered a consuming act in itself in some contexts, for which an interaction event is created, as it is assumed the user has seen the displayed content). That is, the term “consumption” can cover both active consumption, where it is evident the user has made a deliberate choice to consume a specific piece of content, and passive consumption, where all that is known is that a specific piece of content has been rendered available to a user and it is assumed he has consumed it.

To implement the social media system, a back-end infrastructure in the form of at least one data centre is provided. By way of example FIG. 2 shows first and second data centres 108a, 108b connected to the network 102, however as will be appreciated this is just an example. Large social media systems in particular may be implemented by a large number of data centres geographically distributed throughout the world. Each of the data centres 108a, 108b is shown to comprise a plurality of servers 110. Each of the servers 110 is a physical computing device comprising at least one processing unit 112 (e.g. CPU core), and electronic storage 114 (memory) accessible thereto. An individual server 110 can comprise multiple processing units 112; for example around fifty. An individual data centre can contain tens, hundreds or even thousands of such servers 110 in order to provide the very significant processing and memory resources required to handle the large number of social interactions between the social media users 106 via the social media platform. In order to publish new content and consume existing content, the user devices 104 communicate with the data centres 108a, 108b via the network 102. Within each of the data centres 108a, 108b, data can be communicated between different servers 110 via an internal network infrastructure of that datacentre (not shown). Communication between different data centres 108a, 108b, where necessary, can take place via the network 102 or via a dedicated backbone 116 connecting the data centres directly. Those skilled in the art will be familiar with the technology of social media and its possible implementations so further details of this will not be described herein.

The frequent and varied social interactions between a potentially very large number of social media users 106 contains a vast array of information that is valuable in many different contexts. However processing that content to extract information that is meaningful and relevant to a particular query presents various challenges.

The described embodiments of the present invention provide a content processing system which processes events of the kind described above in order to respond to queries from querying users 120 with targeted information relevant to those queries, in the manner outlined above. The querying users 120 operate computer devices 118 at which they can generate such queries and submit them to the content processing system.

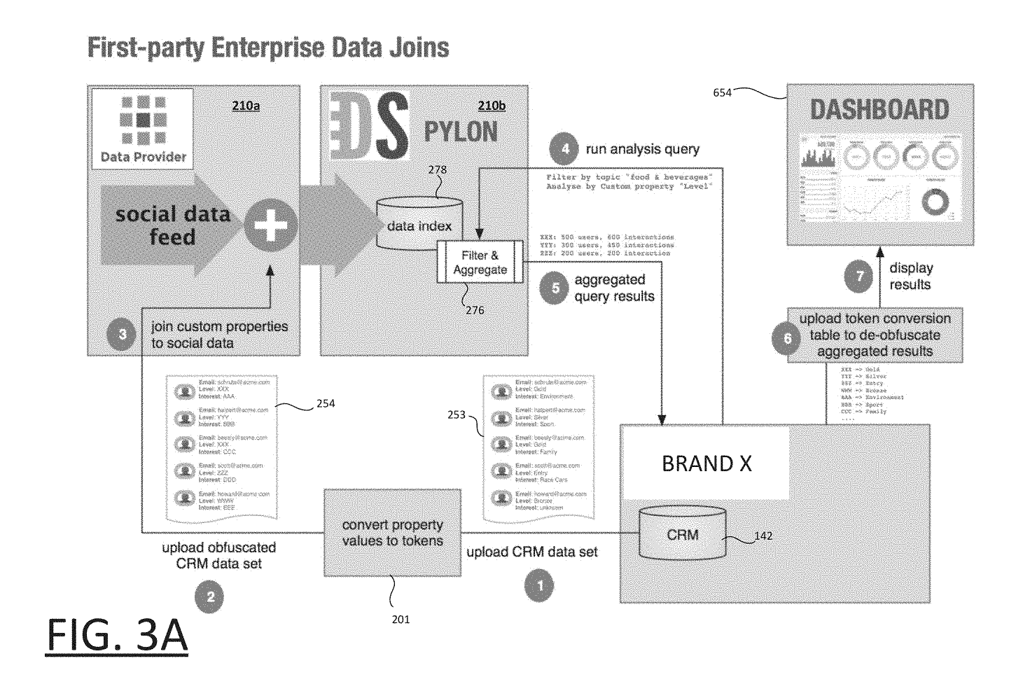

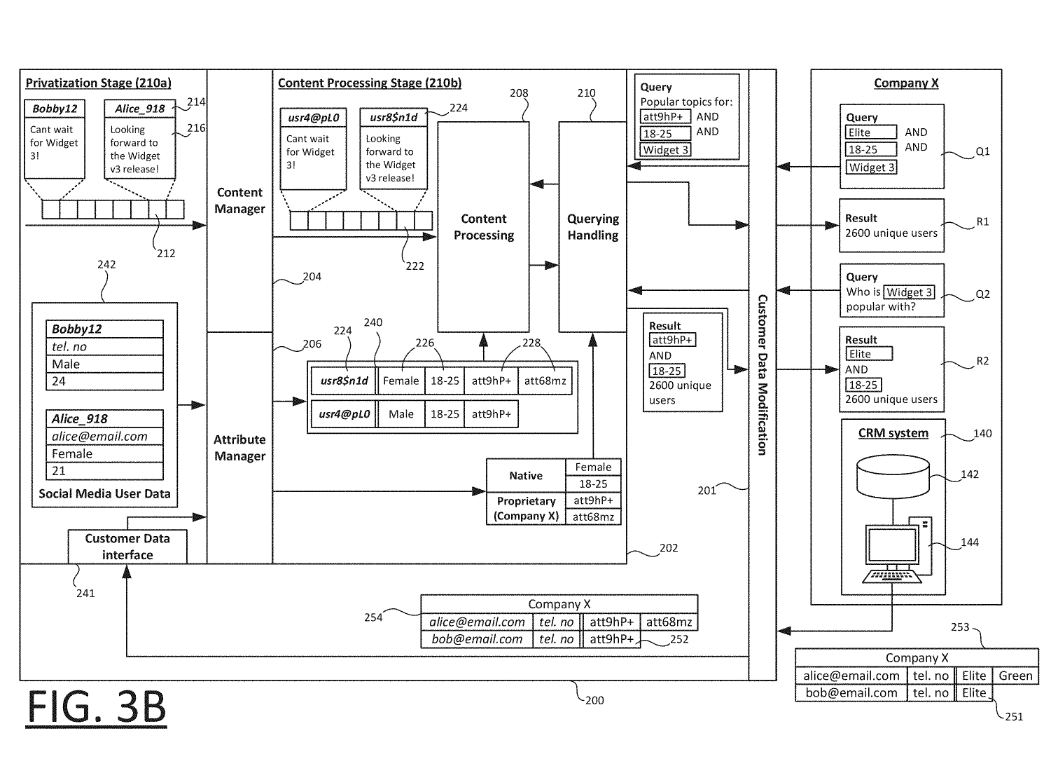

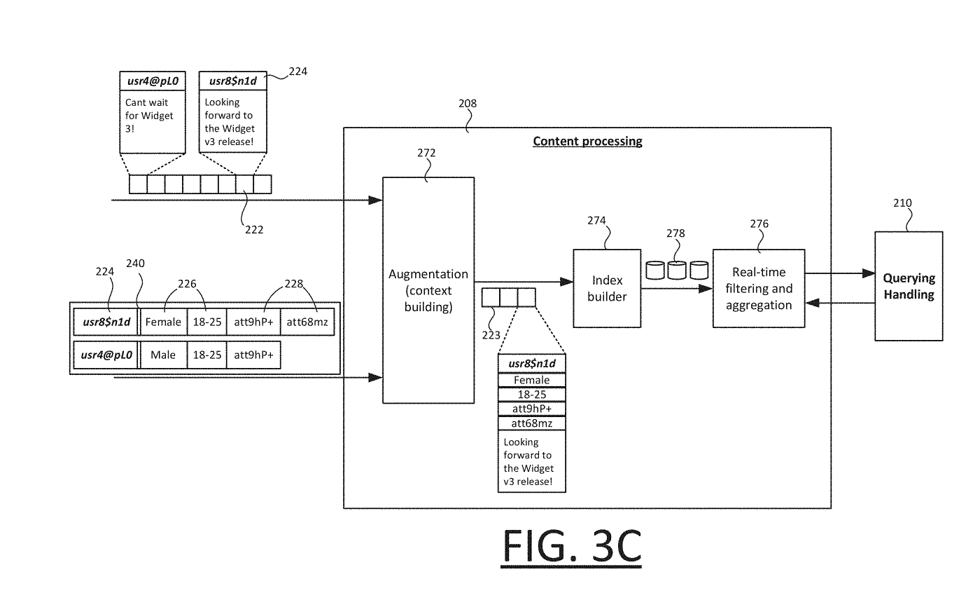

With reference to FIGS. 3A and 3B, a data processing system 200 comprising the content processing system 202 is shown. FIG. 3A shows an overview of the data processing system 300, and FIG. 3B is a block diagram showing further details of the system 300.

The content processing system 202 is shown to comprise a content manager 204, and attribute manager 206, a content processing component 208 and a query handler 210. The content manager 204, attribute manager 206, content processing component 208 and query handler 210 of the content processing system 202 are functional components, representing different high level functions implemented within the content processing system 202.

At the hardware level, the content processing system 202 can be implemented in the data centres 108a, 108b of the social media system back end itself (or in at least one of those data centres). That is, by content processing code modules stored in the electronic storage 114 and executed on the processing units 112. Computer readable instructions of the content processing code modules are fetched from the electronic storage 114 by the processing units 112 for execution on the processing units 112 so as to carry out the functionality of the content processing system 202 described herein. Implementing the content processing system 202 in the social media data centres 108a, 108b themselves is generally more efficient, and also provides a greater level of privacy and security for the social media users 106, as will become apparent in view of the following. However, it is also viable to implement it in a separate data centre (particularly when only public content is being processed) that receives a firehose(s) from the social media platform via the Internet 102.

As explained below, the content manager 204 and attribute manager 206 form part of a privatization stage 210a of the content processing system 202. They co-operate so as to provide an internal layer of privacy for social media users by removing all Personally Identifiable Information (PII) or sensitive user information like phone numbers, card numbers, email addresses etc. from the events before they are passed to the content processing component 208. That is, to remove any sensitive private information. The content processing component 208 and query handler 210 constitute a content processing stage 210b of the content processing system 202, at which events and attributes are processed without ever having access to the users' underlying identities in the social media platform. This privatization is particularly important for private content.

The steps taken to remove the user-identity can be seen as a form of anonymization. However, for the avoidance of doubt, it is noted that removing the user-identity does not fully anonymize the events 212 or user data, as it may still be possible to identify individual users through careful analysis based on their attributes and behaviour. For this reason, the anonymized events and user data are never released by the content processing system 202, and the additional anonymization steps outlined above are taken on top of the removal of the user identity to ensure that individual users can never be identified from the aggregate information released by the system 202. In other words, it is acceptable for the anonymization provided by this internal privacy layer to be a “best effort” anonymization, because additional privacy layers are provided on top of this within the system.

To implement the privatization, the content manager 204 receives events 212 of the social media platform where, as noted, each of the events 212 represents a social interaction that has occurred on the social media platform and comprises a user identifier 214 of one of the social media users 106 who performed that interaction. That is, the user who published or consumed the piece of content to which the event relates. The user identifiers 214 in the events 212 constitute public identities of the social media users 106. For example, these can be user names, handles or other identifiers that are visible or otherwise accessible to other social media users 106 who can access the published content in question. As part of the privatization stage 210a, the content manager modifies the events 212 to replace the public identifiers 214 with corresponding anonymized user identifiers 224 in the modified events 222, which can for example be randomly generated tokens. Within the content processing stage 210b, the anonymized tokens 224 act as substitutes for the public identifiers 214. The content manager 204 replaces the public identifiers 214 with the anonymous tokens 224 in a consistent fashion, such that there is a one-to-one relationship between the public identifiers 214 and the corresponding tokens 224. However, the public identifiers 214 themselves are not rendered accessible to the content processing stage 210b at any point.

Beyond the fact that these anonymized identifiers 224 allow each user's events to be linked together, these anonymized tokens 224 do not convey any information about the identity of the social media users 106 themselves.

As such, an important function of the attribute manager 206 is one of generating what are referred to herein as “anonymized user descriptions” 240. Each anonymized user description 240 comprises a set of attributes for one of the social media users 106 and is associated with the anonymized user identifier 224 for that user. In the example of FIG. 3B, each of the anonymized user descriptions 240 comprises a copy of the anonymized user identifier 224 and is provided to the content processing component 208 separately from the modified events 222. This in turn allows the content processing component 208 to link individual events 222 with the attributes for the user in question by matching the anonymized tokens in the anonymized user descriptions 240 to those in the events 224, and augmenting those events with those attributes. The user descriptions 240 can be updated as the user attributes change, or as new user information becomes available, for incorporation in subsequent events. Alternatively, the user attributes could instead be provided to the content processing component 208 as part of the events 222 themselves.

The attribute manager 206 can determine the user attributes for the anonymized user descriptions 240 from user data 242 of the social media system itself. For example, the user data that forms part of the social media user's accounts within the social media system. The social media user data 242 can for example comprise basic demographic information such as gender, age etc. From this, the attribute manager 206 can determine basic user attributes such as gender attributes, age (or age range) attributes etc.

User attributes determined from the user data 242 of the social media system itself are referred to herein as a first type of user attribute or, equivalently, “native” attributes (being native to the social media platform itself). As explained in detail below, the attribute manager 206 is also able to determine user attributes of at least a second type in certain circumstances, which are handled differently within the content processing system 202. These are referred to, equivalently, as “proprietary” attributes for reasons that will become apparent. Native user attributes are labelled 226 in FIG. 3B whereas proprietary attributes are labelled 228.

The query handler 210 handles incoming queries submitted to the content processing system 202 by the querying users 120. These queries are essentially requests for aggregate information relating to the publication and/or consumption of content within the social media system. As noted, this may involve applying a querying filter(s) where, in general, a querying filter can be defined in terms of any desired combination of user attributes and/or tags. The content processing component 208 filters the events 222 to filter out any events that do not match the querying filter.

The basic elements of a query essentially fall into one of two categories: elements that specify user demographics (in terms of user attributes); and elements that specify particular content (in terms of tags). For the former, the aim is to filter out events 222 for users outside of the desired demographic (filtering by user attribute). For the latter, the aim is to filter out events that are not relevant to the specific tags, (filtering by metadata).

For example, for a query defined in terms of one or more user attributes and one or more tags (see above), the content processing component 208 filters out any events 222 for users without those attributes and any events 222 that do not match those tags, leaving only the events for users having those attributes and which also match those tags. From the filtered events (i.e. the remaining events) the content processing component 208 can extract the desired aggregate and anonymized information.

As will be appreciated, this is a relatively simple example presented for the purposes of illustration and it is of course possible to build more a complex queries and to return results with more detailed information. For example, a general query for any popular topics for a specified demographic of users (as defined by set of attributes) may return as a result one or more popular topics together with a number of unique users in that demographic and who been engaging with that topic. As another example general query requesting information about which demographics a specified topic is popular with may return a set of user attributes and a number of unique users having those attributes and who have engaged with that topic recently. Here, the concept mentioned above of over-indexing becomes pertinent: for example, the response to the query may identify demographics (in terms of attributes) for which the topic is over-indexing, i.e. indicating that this topic is not merely popular within that demographic but more popular than the average across all demographics (or at least a wider demographic).

As noted, certain types of tag, such as topic, can be generated by processing the pieces of published content 216 themselves, for example using natural language processing in the case of text and image recognition in the case of static images or video. This enrichment can be performed before or after the user-identities have been stripped out (or both).

Queries submitted to the content processing system 202 are handled and responded to in real time, where real time in this particular context means that there is only a short delay of two seconds or less between the query being received at the content processing system 202 and the content processing system 202 returning a result. The filtering needed to respond to the query is performed by the content processing component 208 in response to the submission of the query itself. That is, the content processing component 208 performs the filtering in real-time when the query is received. Any pre-processing or enrichment of the events need not be performed in real time, and can for example be performed as the events are received at the relevant part of the system.

Once the events 222 have been filtered as needed to respond to the query in question, the content process component 208 extracts, from the filtered events in real-time, anonymized, aggregate information about social interactions on the social media platform. That is, aggregate information about the publication and/or consumption of content by the social media users 106.

As will be apparent, new events 212 will be constantly generated as the content processing system 202 is in use. For example, for popular social media platforms, hundreds of thousands of new events may be generated every minute as users frequently publish new content or consume existing content. To handle the large volume of data, the resulting anonymized events 222 are only retained at the anonymized content processing stage 210b for a limited interval of time, for example 30 days or so. In that case, the result returned in response to a query relates to activity within the social media platform within that time interval only.

Alternatively, rather than a blanket retention rule of this nature, the amount of time for which events 222 are retained may be dependent on the events themselves. For example events relating to more popular content may be retained for longer. This allows older information for more popular content to be released upon request.

FIG. 3C shows further details of the content processing component 210 in one embodiment of the present invention. The content processing component is shown to comprise an augmentation component 272, which receives the events 222 and the user descriptions 224. These can for example be received in separate firehoses. The augmentation component augments the events 224 with the user attributes 226, 228. That is, for every one of the events 222, the augmentation component adds, to that event 222, a copy of the user attributes associated with the user identifier in that event 222. The augmented events 223 are passed to an index builder 274, which corresponds to the index builder 600 in FIG. 1A and operates as described above to create indexes 278 populated with selected and enriched ones of the augmented events 223. The indexes 278 are rendered accessible to a real-time filtering and aggregation component 276 of the content processing component 210, which operates as described above with reference to FIG. 1B in order to filter and aggregate events in the index in real-time as and when it is instructed to do so by the query handler 210. The indexes 278 and filtering and aggregation component 276 are also shown in FIG. 3A. Events 223 are purged from the indexes 278 in accordance with the retention policy.

Interface with Customer Management System:

As indicated above, in accordance with the described embodiments of the present invention, the attribute manager 206 can not only determine native user attributes 226 from the user data 242 of the social media platform itself but can, in addition, determine proprietary user attributes 228 for certain users.

These proprietary attributes 228 are referred to as such because they are determined from proprietary customer data received from a customer management system, which is a CRM (customer relationship management) system 140. The CRM system 140 is shown in FIG. 2 to comprise a “brand database” 142 and at least one computing device 144 having access to the brand database 142 and connected to the network 102.

The brand database 142 is a customer database of the customer data. The inventors of the present invention have recognised that customer data of this nature can provide rich user demographic information above and beyond the basic demographic information that forms part of the social media user data 242.

The content processing system 202 is shown to comprise a customer data interface 241 via which the computing device 144 of the CRM system 140 can connect to the content processing system 202. A version 254 of the customer data from the customer database 142 is received at the content processing system 202 via the customer data interface 241, where it is processed by the attribute manager 206 to determine the proprietary attributes 228.

The customer data embodies information about the customers of a proprietor of the customer data, who is typically a company or other organisation (“brand”). The nature of the customer data may be quite specific to the company in question, and can for example be generated over time as customers make purchases or otherwise interact with that company. Within the customer data, customers are identified by identity data such as email addresses, telephone numbers etc. (and not necessarily the public identifiers 214 that form the basis of their identity within the social media platform). The company data also defines attributes of those customers specific to that company, such as whether that company considers a particular customer to be an “elite customer”, a “green customer” (that is who has expressed a particular interest in green technology), or a rating assigned by the companies to that customer such as gold, silver, bronze, platinum etc. As will be appreciated the form and nature of these attributes is highly dependent on the nature of the company, and will very likely vary from company to company in practice. It is these attributes in the company data that form the basis of the proprietary attributes within the content processing system 202. They are proprietary in the sense that the company may have put considerable time and resources into compiling these attributes as a way to better understand their customers or into collecting more information directly from their own customers.

Given the proprietary and confidential nature of the customer data, and its value to the company in question, preferably a customer data modifier 201 is implemented within the data processing system 200. The customer data is received from the CRM system 140 at the content processing system 202 (step 2, FIG. 3A) via the customer data modifier 201 (step 1, FIG. 3A). The customer data modifier 201 modifies the customer data to convert interpretable user attributes therein, i.e. attributes in a form that is interpretable to human such as text strings “elite”, “green”, “bronze level” etc., to an uninterpretable form, i.e. that is not interpretable to a human, by replacing each of the interpretable attributes with a corresponding randomly generated token. In this way, it functions as an attribute anonymization layer between the content processing system 202 and the company.

The original customer data containing the interpretable attributes is labelled 253 in FIG. 2 with the uninterpretable attributes being labelled 251. The modified customer data, i.e. as modified by the customer data modify 201, is labelled 254 whereas the uninterpretable attributes (randomised tokens) are labelled 252.

It is these uninterpretable attributes 252 in the modified customer data 242 that are determined by the attribute manager 206 as the proprietary attributes 208 within the content processing system 202 (step 3, FIG. 3A), by extracting them from the modified customer data 254. The interpretable attributes 251 are never rendered available to the content processing system 202. Thus within the content process in system 202 it is not possible to discern the meaning of the proprietary attribute 228, thereby protecting the company's valuable customer data. In other words, the user attributes 251 in the original customer data 253 are anonymized before arriving at the content processing system 202.

Although it is not possible to determine the meaning of the user attributes in the modified customer data 254, it still contains the identity data of the customers. This identity data is compared by the attribute manager 206 with identity data in the social media user data 242 in order to match each entry in the customer data 244 to one of the social media users 106 (where possible). Matching the user data 242 of the social media platform to the customer data 244 allows the attribute manager 206 to generate one anonymized user description 240 for each unique user of the social media platform 106 which can contain both proprietary and native attributes 226, 228 where that user is also a customer of the company in question.

Within the content processing system 202, the proprietary attributes 228 can be used in exactly the same way as the native attributes 226 in order to provide highly targeted aggregate information in response to particular queries from the company in question. For example, as indicated in FIG. 3B, the company can now submit a query for a user demographic defined as their “Elite” customers (proprietary attribute) who are in the age range of 18 to 25 (generic, native attribute). This is just one example, and other examples are given below.

It is convenient for the company to be able to formulate this query using the interpretable attribute “Elite”, and in that event the query is submitted by the customer data modifier 201 which replaces the interpretable attribute in the query with the corresponding token so that it can be matched with the anonymized proprietary attributes 228 within the content processing system 202. To respond to this query, the content processing component 208 can filter the anonymized events 222 according to those two attributes as it would for any other such query. By way of example, FIG. 3B shows a first query Q1 for elite customers in the 18-25 age bracket and a topic “widget 3”, to which a result R1 is returned indicating a number of unique users in that demographic who have published or consumed content relating to that topic. The “Elite” attribute is anonymized by the customer data modifier 201 before arrival at the query handler 210.

Similarly a query submitted by the company in question request information about a particular topic (or other tag) can now be responded to with information relating to the proprietary attribute. For example a result may indicate that a particular topic is popular with that companies elite customers in the 18 to 25 age bracket. The result is returned by the customer data modifier 201 as the result released by the query handler 210 will be formulated in terms of the uninterpretable attributes, and the customer data modifier 201 converts it to an interpretable form so that it can be interpreted by the querying user. By way of example, FIG. 3B shows a general query Q2 for “widget 3” topic, where the result R2 has information for “Elite” customers rendered interpretable by the customer data modifier 201.

As another example, step 4 of FIG. 3A shows a simple query from company X requesting a filtering of an index 278 by a topic “food & beverages”, with a breakdown according to proprietary attribute “Level”. The result returned at step 5 indicates, for each of the levels, 1) the total number of interactions in the index 287 that have been performed by users of that level and which relate to that topic and 2) the total number of unique users of that level who have performed those interactions collectively.

As will be appreciated, this allows proprietary attributes determined from customer data to be incorporated seamlessly into the content processing system 202 alongside native attributes determined from the social media user data 242 itself. However it is important to note that, from the perspective of the company, it is highly undesirable for unauthorised users (e.g. outside of that company) to be able to submit queries relating to their proprietary user attributes.

For this reason, the attribute manager 206 is configured to mark the proprietary attributes 228 within the content processing system 202 as proprietary to the company in question, and is configured in particular to indicate to the query handler 210 the type of each of the user attributes within the content processing system 202.

The company data 244 is received with associated “release authorisation data” for that customer data, which specifies under what circumstances aggregate content-related information related to proprietary attributes determined from the customer data can be released. That is, the release authorisation data serves as access control data, which controls who can filter by or receive those attributes (for example, who can receive a breakdown according to those attributes). This allows the proprietor of the customer data to specify when those proprietary attributes can and cannot be used to respond to queries submitted to the content processing system 202.

By way of example, a company can create an account within the content processing system 202. This can be a user account, or an organisation account (such as a business or enterprise account) linked to multiple users within the organisation. In that case, the company data 254 can be uploaded in association with that account, for example along with one or more account credentials, an authentication token or other suitable indicator of that account. In this case, it is the account indicator that serves as the release authorisation data in that it specifies that only an authorised user or users of that account are authorised to submit queries pertaining to that company's proprietary user attributes and receive results pertaining to those attributes.

Other examples of release authorisation data include for example data that specifies that only a particular device or user is authorised to submit such queries/receive such results, or that such queries/results may only be submitted from/released to a particular network address etc. For example, only allowing such queries and results to be submitted by/released to the CRM system 140 itself.

The query handler 210 of the content processing system 202 restricts the release of aggregate content-related information pertaining to proprietary user attributes 228 according to the release authentication data received for the customer data 254 from which they are determined, in line with CRM authorities for the brand database 142 (for example, only certain staff member may be permitted access to the customer data, and only those members of staff may be allowed to run queries). For example it can refuse a query to filter on one of those attributes from an unauthorised source.

This ensures that the company providing the customer data has complete control over who can and cannot submit requests relating to their customer data. Together with customer data modifier 201, this provides a highly secure means by which a company can incorporate their customer data into the content processing system 202.

In contrast, anonymized, aggregate content-related information relating only to the native attributes 226 can be released without that restriction. For example this may be released to any authorised user of the content processing system 202 in some cases. In other cases, other restrictions on what data can be released may apply but they are not determined by the release authorisation data. That is, information pertaining only to the native user attributes may or may not be selectively released, but in any event is released independently of the authorisation data received for the customer data.

As indicated above, whilst the privatization stage 210a is particularly important for private content, it is not essential, and can in particular be omitted for public content in some contexts. In that case, the above techniques can be applied to the original events 212 items directly, using the public identifiers 214 in place of the anonymized identifiers 224.

It will be appreciated that the above embodiments have been described only by way of example. Other variations and applications of the present invention will be apparent to the person skilled in the art in view of the disclosure given herein. The present invention is not limited by the described embodiments, but only by the appendant claims.

1. A content processing system for processing content items of a content publication platform having a plurality of users, the content processing system comprising:
a customer data interface configured to receive from a customer management system customer data and release authorization data for the customer data;
a content input configured to receive content items of the content publication platform, each relating to a piece of published content and comprising an identifier of at least one of the users who has published or consumed it;
an attribute manager configured to determine, for the users of the content publishing platform, user attributes of a first type from user data of the content publication platform and user attributes of a second type from the customer data;
a query handler configured to respond to submitted queries by selectively releasing aggregate content-related information; and
a content processing component configured to process the content items and the user attributes to extract the aggregate content-related information for release;
wherein the query handler is configured to restrict the release of aggregate content-related information pertaining to the second type of user attribute according to the release authorization data received for the customer data.

2. A content processing system according to claim 1, wherein the user attributes of the second type are uninterpretable tokens.

3. A data processing system comprising:
a content processing system according to claim 2; and
a customer data modifier configured to modify customer data from a customer database of the customer management system to replace interpretable user attributes therein with the uninterpretable tokens, and provide the modified customer data to the content processing system via the customer data interface for processing, wherein the interpretable user attributes are not rendered accessible to the content processing system.

4. A data processing system according to claim 3, wherein the customer data modifier is configured to receive a query comprising at least one of the interpretable user attributes, and modify that query for submission to the query handler by replacing the interpretable attribute with a corresponding one of the uninterpretable tokens.

5. A content processing system according to claim 1, wherein, for each of the queries, the aggregate content-related information to be released is extracted by the content processing component in response to the submission of that query to content processing system.

6. A content processing system according to claim 1, wherein the content processing component is configured to filter the content items according to the user attributes;
wherein the query handler is configured to refuse a query requesting information for content items filtered according to the second type of user attribute unless authorized by the release authorization data.

7. A content processing system according to claim 1, wherein the content processing component is configured to filter content items according to metadata of the content items;
wherein the query handler is configured to release aggregate content-related information extracted from the filtered content items and pertaining to the second type of user attribute only when authorized by the release authorization data.

8. A content processing system according to claim 4, wherein aggregate content-related information pertaining only to the first type of user attribute is released to any authorized user of the content processing system.

9. A content processing system according to claim 1, comprising a content manager configured to anonymize the identifiers of the users in the content items before they are processed by the content processing component.

10. A content processing system according to claim 9, wherein the attribute manager is configured to associate the user attributes with the anonymized user identifiers for processing by the content processing component.

11. A content processing system according to claim 1, wherein the attribute manager is configured to determine the attributes for the users by matching user identity data in the customer data to user identity data in the user data of the content publication platform.

12. A content processing system according to claim 11, wherein the identity data comprises email addresses, device identifiers, public user identifiers and/or telephone numbers.

13. A content processing system according to claim 1 wherein the release authorization data indicates at least one entity for which the release of the aggregate content-related information pertaining to the second type user attribute is authorized.

14. A content processing system according to claim 13, wherein the authorized entity is:
an organization,
a device,
a user,
an account within the content processing system, or
a network address.

15. A content processing system according to claim 14, wherein the release authorization data comprises a credential or an authentication token for the account within the content processing system, thereby indicating the account.

16. A content processing system according to claim 1, wherein the content processing component comprises an augmentation component configured to augment the content items with the user attributes, each of the augmented content items comprising a copy of the user attributes associated with its user identifier.

17. A content processing system according to claim 1, wherein the content processing component comprises an enrichment component configured to generate metadata from the pieces of content and enrich the content items with the metadata, each of the enriched content items comprising the metadata derived from its piece of content.

18. A method of processing content items of a content publication platform having a plurality of users, the method comprising, at a content processing system:
receiving, via a customer data interface from a customer management system, customer data and release authorization data for the customer data;
receiving content items of the content publication platform, each relating to a piece of published content and comprising an identifier of at least one of the users who has published or consumed it;
determining, for the users of the content publishing platform, user attributes of a first type from user data of the content publication platform and user attributes of a second type from the customer data;
responding to submitted queries by selectively releasing aggregate content-related information, the aggregate content-related information being extracted for release by processing the content items and the user attributes, wherein the release of aggregate content-related information pertaining to the second type of user attribute is restricted according to the release authorization data received for the customer data.

19. A computer program product comprising executable instructions stored on a computer readable storage modicum and configured when executed at a content processing system to implements steps of:
receiving, via a customer data interface from a customer management system, customer data and release authorization data for the customer data;
receiving content items of the content publication platform, each relating to a piece of published content and comprising an identifier of at least one of the users who has published or consumed it;
determining, for the users of the content publishing platform, user attributes of a first type from user data of the content publication platform and user attributes of a second type from the customer data;
responding to submitted queries by selectively releasing aggregate content-related information, the aggregate content-related information being extracted for release by processing the content items and the user attributes, wherein the release of aggregate content-related information pertaining to the second type of user attribute is restricted according to the release authorization data received for the customer data.

20. A system for processing user events of a platform having a plurality of users, the system comprising:
a customer data interface configured to receive from a customer management system customer data and release authorization data for the customer data;
an input configured to receive user events of the platform, each comprising an identifier of at least one of the users;
an attribute manager configured to determine, for the users of the platform, user attributes of a first type from user data of the platform and user attributes of a second type from the customer data;
a query handler configured to respond to submitted queries by selectively releasing aggregate information related to user events; and
a processing component configured to process the user events and the user attributes to extract the aggregate event-related information for release;
wherein the query handler is configured to restrict the release of aggregate event-related information pertaining to the second type of user attribute according to the release authorization data received for the customer data.
